(19) United States
(12) Patent Application Publication
(10) Pub. No.: US 2002/0145479 A1
(43) Pub. Date: Oct. 10, 2002

(54) Series connections of lumped elements on slotline

(76) Inventor: Blythe C. Deckman, Santa Rosa, CA (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/832,506

(22) Filed: Apr. 10, 2001

(51) Int. Cl. H01P 1/00

(52) U.S. Cl. 331/100; 333/247

(57) ABSTRACT

Method of series connecting lumped elements in a slotline. A lumped element such as a resistor or diode is series connected in a slotline by inserting a high impedance stub in a portion of the slotline, and placing the series element across the junction of the slotline and the high impedance stub.

### BACKGROUND OF THE INVENTION

1. Field of the Invention

The present invention pertains to the art of microwave electronics, more particularly to integrating lumped components into transmission systems.

2. Art Background

As frequencies used in electronic devices increase, more and more care must be given to wiring, and especially to the layout used in printed circuit boards and similar circuits. As signals transition through high frequency radio waves, to microwaves, simple conductors become transmission lines.

Regardless of the method used to carry the signal from one location on a board to another, requirements remain for the insertion of electrical elements such as resistors, diodes, capacitors and the like, called lumped elements. For example, a series resistor may be needed to reduce the amplitude of a signal, or a series diode may be needed for its specific electrical properties.

At frequencies and in systems where lumped element parasitics such as stray lead inductance and capacitance are unimportant, a variety of circuit architectures are available. At frequencies and in circuits where lumped element parasitics need to be minimized, slotline provides an attractive transmission system design, but a suitable method to connect series lumped elements is needed.

### SUMMARY OF THE INVENTION

Lumped elements are introduced as series connections in a slotline circuit by forming a high impedance stub in the slotline, and placing the lumped element at the junction of the slotline and the high impedance stub. Since the stub presents a high impedance to RF current, that current will preferentially flow through the series lumped component.

### BRIEF DESCRIPTION OF THE DRAWINGS

The present invention is described with respect to particular exemplary embodiments thereof and reference is made to the drawings in which:

FIG. 1 shows a cross section of a slotline,

FIG. 2 shows a top view of a slotline, and

FIG. 3 shows a top view of a slotline with a series lumped element according to the present invention.

### DETAILED DESCRIPTION

With increasing signal frequency, signal transmission on printed wiring boards moves from simple interconnections to transmission lines. One such transmission line is slotline, and is known to the art, as shown in “Microstrip Lines And Slotlines,” by K. C. Gupta, R. Garg and I. J. Bahl.

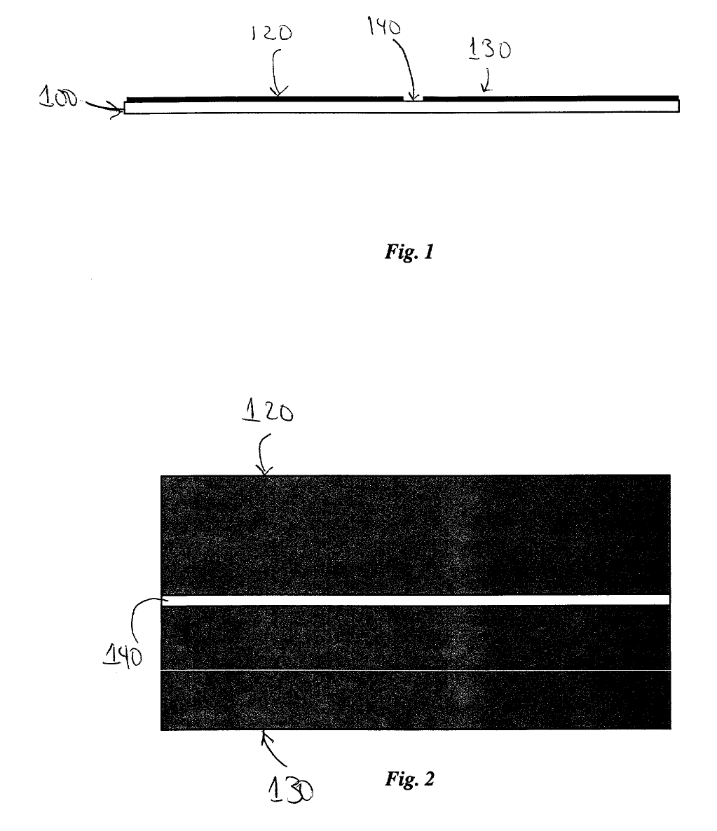

Slotlines are useful and efficient means for propagating microwave signals. Referring to the cross section shown in FIG. 1, dielectric substrate 100 has conductors 120 and 130, and is blank on the other side. The separation between conductors 120 and 130 forms the slotline 140 which carries microwave energy. As is known to the art, the characteristic impedance of slotline 140 is determined by the width of the slotline, and the characteristics of dielectric 100 and conductors 120 and 130.

FIG. 2 shows a top view. Slotline 140 is formed by the gap between conductors 120 and 130. In such a slotline, the electric field emanates from one conductor and terminates on the other. RF current flows along the edges of conductors 120 and 130 which form the slot.

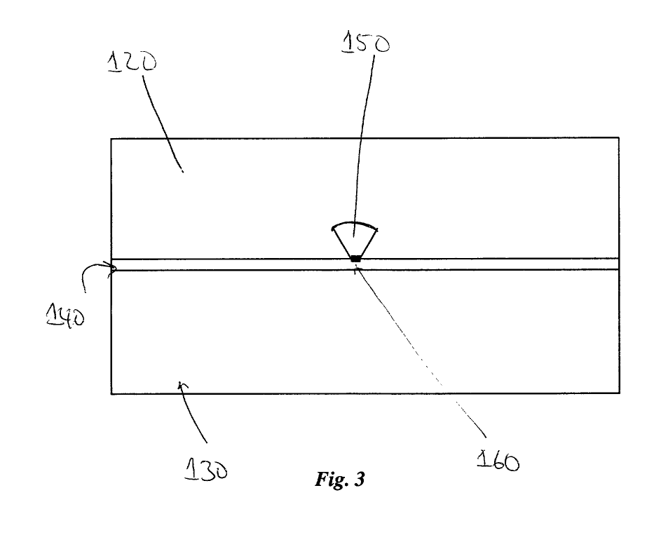

FIG. 3 shows a top view of a slotline according to the present invention. Since RF current flows along the edges of the conductors in a slotline, interrupting an edge would interrupt the current. In the present invention, a high impedance stub is placed on the edge of the slotline. A transmission line having a length which is an odd multiple of ¼ wavelength will be seen as a high impedance. In the preferred embodiment, as shown in FIG. 3, a radial stub 150 is used. Lumped circuit element 160 is placed at the connection of conductor 120 and stub 150. Since stub 150 presents a high impedance to RF current, RF current flows through lumped circuit element 160. Such lumped circuit elements may be discrete components to be fastened to the circuit, or may be formed by depositing suitable material directly on the dielectric substrate. In the preferred embodiment, the substrate material is sapphire. Other suitable materials, such as ceramics, and circuit board materials suitable for microwave frequencies, such as Beryllium Oxide or PTFE or ceramic loaded laminates may be used.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. A slotline containing a series lumped component comprising:
a slotline,
a high impedance stub joined to the slotline, and
a lumped component connected across the high impedance stub at its junction with the slotline.

2. The slotline of claim 1 where the high impedance stub is one quarter wavelength.

3. The slotline of claim 1 where the high impedance stub is an odd multiple of one quarter wavelength.

4. The slotline of claim 1 where the stub is a radial stub.

5. The slotline of claim 1 where the series lumped component is a resistor or a capacitor.

6. The slotline of claim 1 where the series lumped component is a diode.

7. A method of inserting a lumped component in a slotline comprising:
joining a high impedance stub to the slotline, and
placing a lumped component across the junction of the slotline and the high impedance stub.

8. The method of claim 7 where the high impedance stub is an odd multiple of a quarter wavelength.

9. The method of claim 7 where the high impedance stub is a radial stub.
